(19) United States
(12) Patent Application Publication
(10) Pub. No.: US 2005/0103803 A1
(43) Pub. Date: May 19, 2005

(54) Sealing device for a container

(76) Inventors: Mu Sung Hung, Taiping City (TW); Shen Chin Yin, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/714,648

(22) Filed: Nov. 18, 2003

(51) Int. Cl. B67D 1/16

(52) U.S. Cl. 222/109

(57) ABSTRACT

A sealing device for a container, which has a vault and an opening defined in the vault of the container, includes a skirt upwardly extending from the vault of the container surrounding the opening the in the vault of the container and having a distal edge formed with a series of teeth. A hollow guider is partially longitudinally received in the skirt. The guider includes a body received in the skirt and having an annular lip laterally extending from the body. The guider has a series of teeth formed on the annular lip and corresponding to the series of teeth of the skirt. The series of teeth of the guider is engaged to that of the skirt to prevent the guider from being rotated. A cap is mounted to the skirt for covering the skirt and the hollow guider.

### BACKGROUND OF THE INVENTION

1. Field of the Invention

The present invention relates to sealing device, and more particularly to a sealing device for a container.

2. Description of Related Art

A conventional sealing device for a container, which includes a vault (5) and an opening (not numbered) defined in the vault (5), in accordance with the prior art shown in FIG. 9 comprises a skirt (51) secured on the vault (5) around the opening and a guider (52) is mounted within the skirt (51) for user to easily drain the fluid in the container. A cap (6) is detachably longitudinally mounted to the skirt (51) to prevent the fluid in the container from being suddenly drained. A washer (61) is mounted between the distal edge of he skirt (51) and the cap (6) to prevent the fluid in the container from leaking when the container is in a slant condition.

However, the washer (61) is fruitless when the cap (6) does not effectively mounted to the skirt (51) to securely clamp the washer (61). In addition, the washer (61) may be transfigured after being continually clamped and released. The washer (61) becomes useless after being transfigured. Furthermore, the washer (61) is deeply mounted in the cap (6) so that to assemble washer (61) in the cap (6) will increase the manufacturing cost of the conventional sealing device for a container.

With reference to FIGS. 10 and 11, another conventional sealing device for a container is shown. The container includes a vault (7) formed on a top portion thereof and an opening (not numbered) defined in the vault (7) of the container. The second embodiment of conventional sealing device comprises a skirt (71) upward extending from the vault (7) surrounding the opening. An annular groove (72) is defined in an inner periphery of the skirt (71) near a top of the skirt (71). A guider (8) is mounted within the skirt (71) and has an annular lip (81) laterally extending from the guider (8). The annular lip (81) is received in the annular groove (72) when the guider is mounted to the skirt (71). A cap (9) is screwed onto the skirt (71) and having a pusher (91) downward extending from an inner periphery of the cap (9). The pusher (91) laterally pushes the guider (8) to make the annular lip (81) abut against the skirt (71) for providing a leakproof effect.

For easily draining the fluid from the container, the guider (8) has a guiding portion (82) longitudinally extending therefrom and a channel (83) defined therein. The guiding portion (82) and the channel (83) sequentially linearly correspond to a handle (3) of the container. However, there is no anti-slip structure between the guider (8) and the skirt (71) so that the guider (8) may be rotated relative to the skirt (71) when mounting/detaching the cap (9). With reference to FIG. 11, the user cannot conveniently drain the fluid from the container when the guiding portion (82) and the channel (83) of the guider (8) does not sequentially linearly correspond to the handle (3).

The present invention has arisen to mitigate and/or obviate the disadvantages of the two conventional sealing devices for a container.

### SUMMARY OF THE INVENTION

The main objective of the present invention is to provide an improved sealing device for a container.

To achieve the objective, the sealing device in accordance with the present invention comprises a skirt upwardly extending from the vault of the container surrounding the opening the in the vault of the container and having a distal edge formed with a series of teeth. A hollow guider is partially longitudinally received in the skirt. The guider includes a body received in the skirt and having an annular lip laterally extending from the body. The guider has a series of teeth formed on the annular lip and corresponding to the series of teeth of the skirt. The series of teeth of the guider is engaged to that of the skirt to prevent the guider from being rotated. A cap is mounted to the skirt for covering the skirt and the hollow guider.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a first embodiment of a sealing device for a container in accordance with the present invention;

FIG. 2 is a cross-sectional view of the sealing device in FIG. 1;

FIG. 3 is a partially enlarged view of the sealing device in FIG. 2;

FIG. 4 is a plan view of the two series of teeth of the skirt and the guider as shown in FIG. 1;

FIG. 5 is an exploded perspective view of a second embodiment of the sealing device for a container in accordance with the present invention;

FIG. 6 is a plan view of the two series of teeth of the skirt and the guider as shown in FIG. 5;

FIG. 7 is an exploded perspective view of a third embodiment of the sealing device for a container in accordance with the present invention;

FIG. 8 is a plan view of the two series of teeth of the skirt and the guider as shown in FIG. 7;

FIG. 9 is a partially cross-sectional view of a first conventional sealing device for a container in accordance with the prior art;

FIG. 10 is a partially cross-sectional view of a second conventional sealing device for a container in accordance with the prior art; and

FIG. 11 is an operational plan view of the two conventional sealing devices when the guider is rotated for 180 degrees.

### DETAILED DESCRIPTION OF THE INVENTION

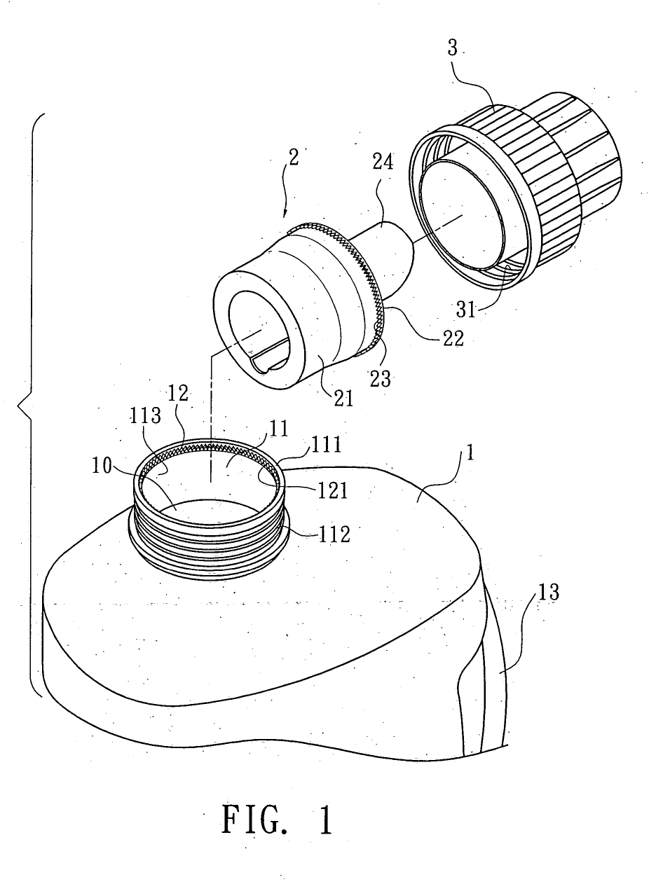

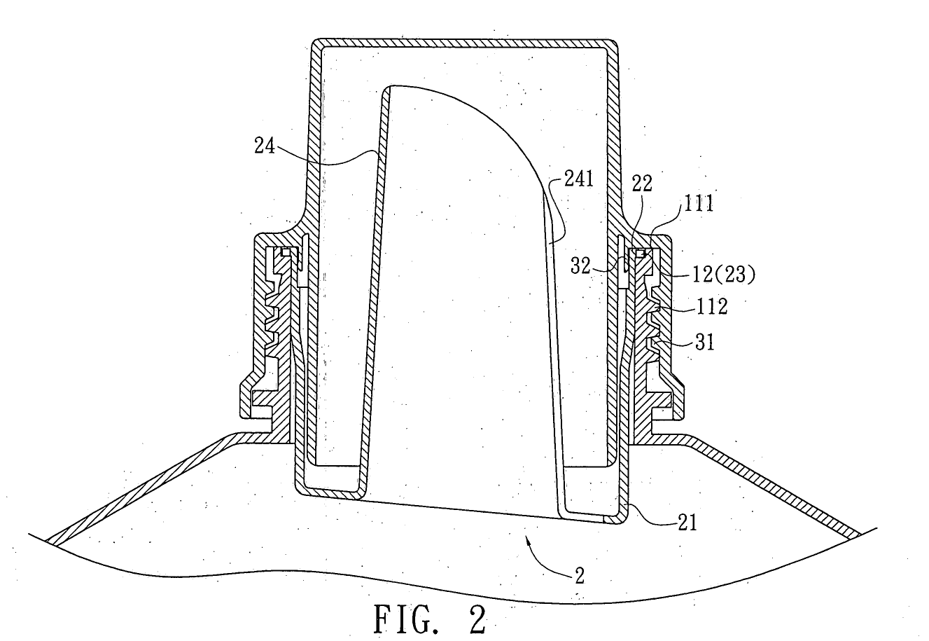

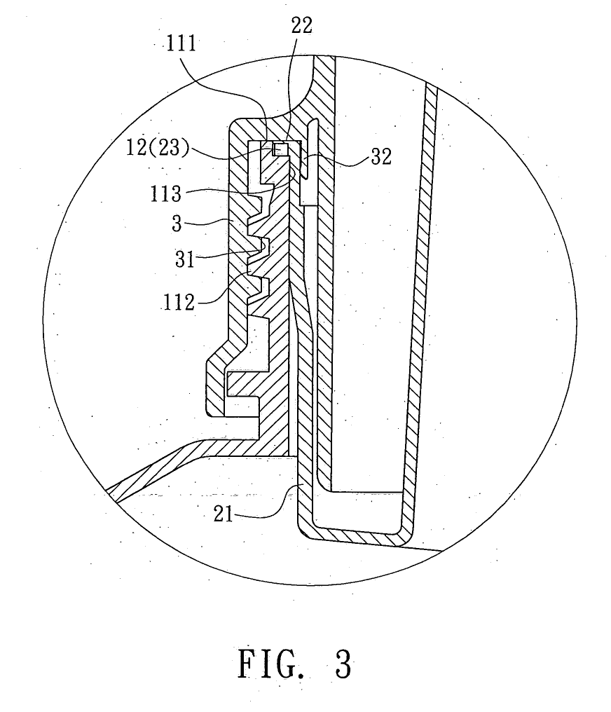

Referring to the drawings and initially to FIGS. 1-3, a sealing device for a container, which has a vault (1) formed on a top thereof and an opening (10) defined in the vault (1), in accordance with the present invention comprises a skirt (11) upwardly extending from the vault (1) surrounding the opening (10), a hollow guider (2) mounted to the skirt (11) and a cap (3) mounted to the skirt (11) for covering the guider (2) and the skirt (11).

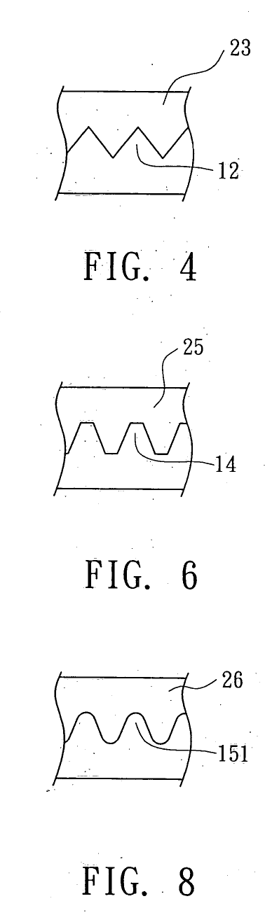

The skirt (11) includes a distal edge (111) formed opposite to the container and a threaded portion (112) formed on an outer periphery of the skirt (11). An annular groove (12) is defined in an inner periphery (113) of the skirt (11) and extends to the distal edge (111) of the skirt (11). A series of teeth (121) is formed on a bottom of the annular groove (12) and extends toward the distal edge (111) of the skirt (11). With reference to FIG. 4, in the preferred embodiment of the present invention, the series of teeth (121) has a triangle-shape and each has an apex toward the distal edge of (111) the skirt (11).

The hollow guider (2) includes a body (21) and an annular lip (22) laterally extending form a top of the body (21). The annular lip (22) is received in the annular groove (12) in the skirt (11) when the guider is mounted to the skirt (11). The annular lip (22) includes one side having a series of teeth (23) formed thereon. The series of teeth (23) of the guider (2) corresponds to the series of teeth (121) of the skirt (11) and is engaged to the series of teeth (121) of the skirt (11) to prevent the guider (2) from being rotated when the cap (3) is securely mounted to the skirt (3). The guider (2) includes an apron (24) extending therefrom and linearly and a channel (241) defined therein. The apron (24) and the channel (241) diametrically correspond to each other and sequentially linearly correspond to a handle (13) of the container.

The cap (3) includes a shape corresponding to the apron (24) of the guider (2) and a threaded inner periphery (31) that is screwed onto the threaded portion (112) of the skirt (11) to longitudinally hold the guider (2) in place. The cap (3) includes an annular pusher (32) extending therefrom toward the guider (2). The annular pusher (32) abuts against an inner periphery of the guider (2) for promoting a leakproof effect between the cap (3) and the guider (2).

When using the container with the sealing device in accordance with the present invention, the user holds the handle (13) of the container and inclines the container, and the fluid in the container is drained out of the container along the apron (24) of the guider (2). The cap (3) can be used as a measuring cup for controlling the draining quantity. The remained fluid in the cap (3) will flow back into the container along the channel (241) in the guider (2) after the cap (3) mounted to the skirt (11) again and the guider (2) is never rotated because the series of the teeth (121) is engaged to that of the guider (2). Consequently, the apron (24) and the channel (241) are kept to sequentially linearly correspond to the handle (13) of the container.

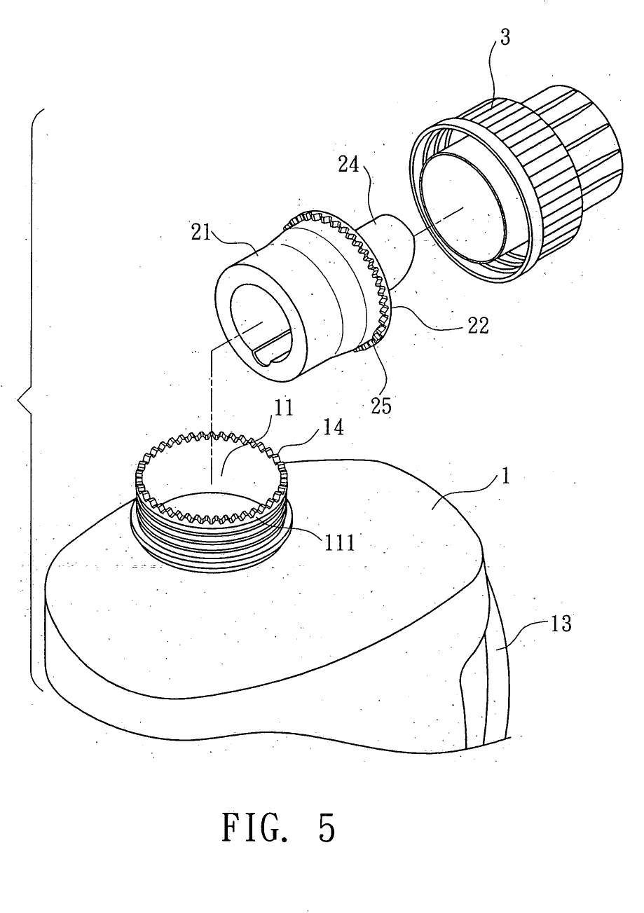

With reference to FIGS. 5 and 6 that show a second embodiment of the present invention, the series of teeth (14) upwardly extends from the distal edge (111) of the skirt (11) and each has a trapezoid shape. The shape of the series of the teeth (25) of the guider (2) corresponds to that of the series of the teeth (14) of the skirt (11) and engaged to the series of the teeth (14) of the skirt (11).

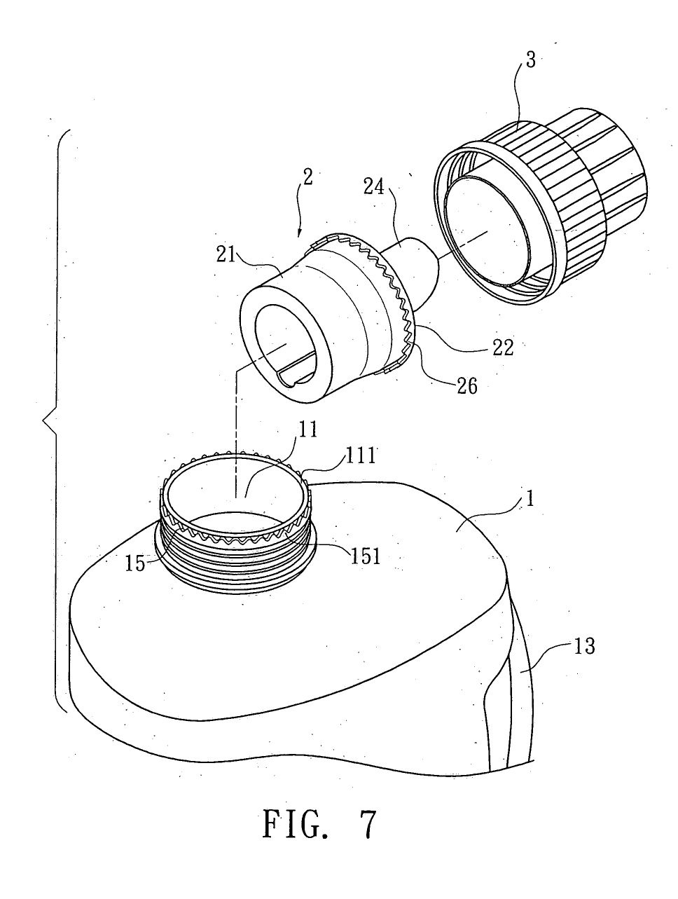

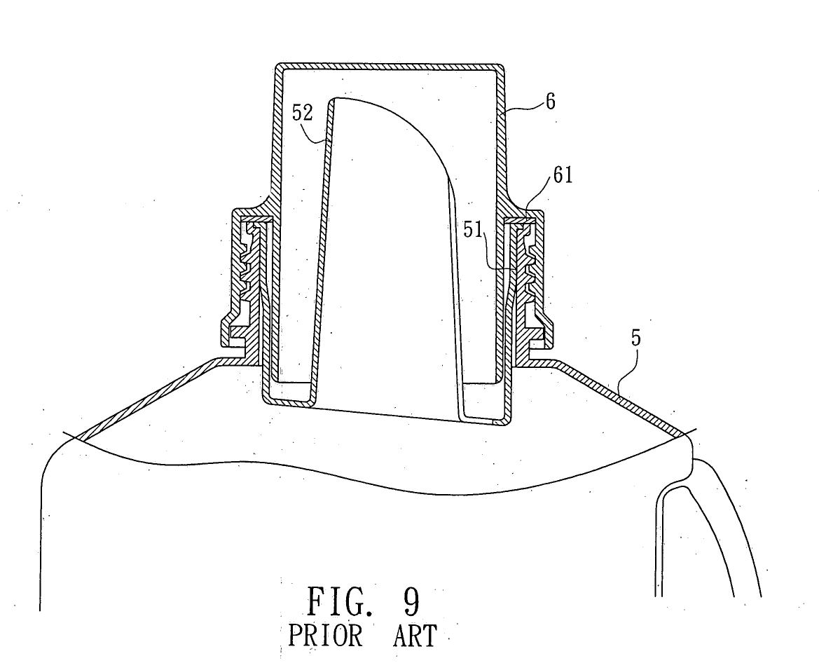

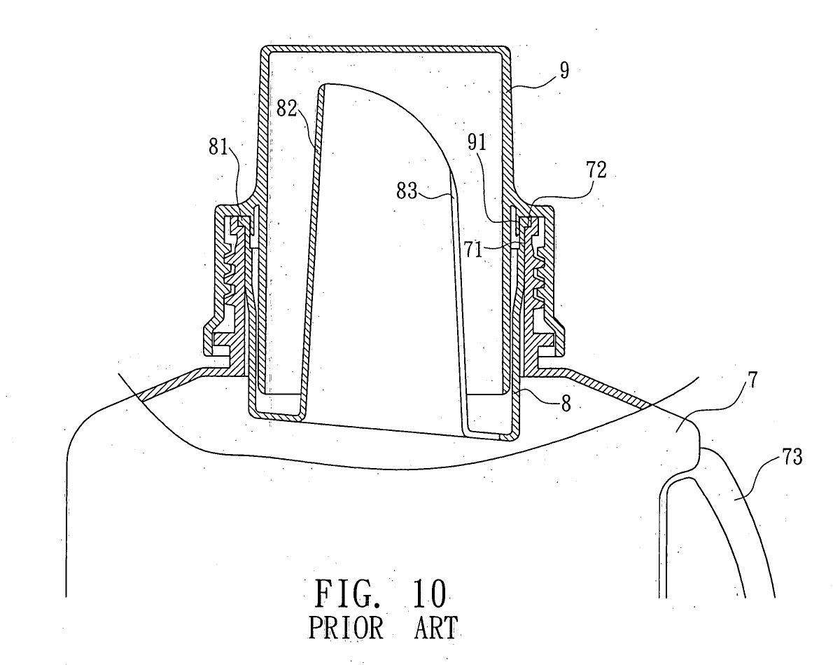

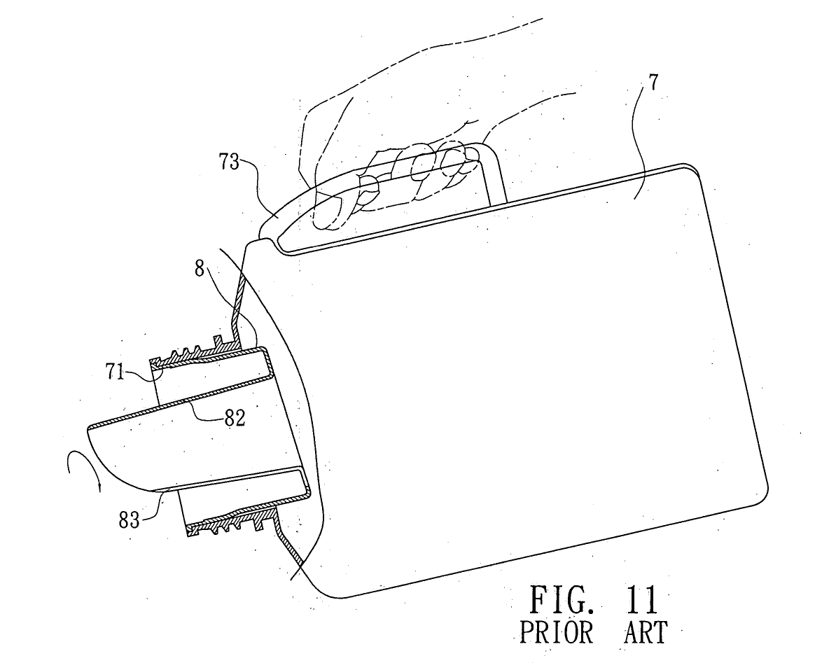

With reference to FIGS. 7 and 8 that show a third embodiment of the present invention, the skirt (11) has an annular groove (15) defined in the outer periphery thereof and extending to the distal edge (111) of the skirt (11). A series of teeth (151) is formed on a bottom of the annular groove (15) toward the annular lip (22) of the guider (2). The shape of the series of the teeth (151) of the skirt (11) is wave-like and the shape of the series of the teeth (26) of the guider (2) corresponds to that of the series of teeth (151) of the skirt (11).

Although the invention has been explained in relation to its preferred embodiment, it is to be understood that many other possible modifications and variations can be made without departing from the spirit and scope of the invention as hereinafter claimed.

1. A sealing device for a container, which has a vault and an opening defined in the vault of the container, comprising:
a skirt upwardly extending from the vault of the container surrounding the opening the in the vault of the container and having a distal edge formed with a series of teeth;
a hollow guider partially longitudinally received in the skirt, the guider including a body received in the skirt and having an annular lip laterally extending from the body, the guider having a series of teeth formed on the annular lip and corresponding to the series of teeth of the skirt, the series of teeth of the guider being engaged to that of the skirt to prevent the guider from being rotated; and
a cap mounted to the skirt for covering the skirt and the hollow guider.

2. The sealing device as claimed in claim 1, wherein the skirt comprises an annular defined in an inner periphery of the skirt and extending to the distal edge of the skirt, and the series of teeth of the skirt is formed on a bottom of the annular groove toward the annular lip of the guider, the annular lip of the guider received in the annular groove in the skirt when the guider mounted to the skirt.

3. The sealing device as claimed in claim 1, wherein the series of teeth of the skirt is form on the distal edge of the skirt toward the annular lip of the guider.

4. The sealing device as claimed in claim 1, wherein the skirt comprises an annular groove defined in an outer periphery thereof and extending to the distal edge of the skirt, and the series of teeth of the skirt is formed on a bottom of the annular groove toward the annular lip of the guider.

5. The sealing device as claimed in claim 1, wherein the skirt comprises a threaded portion formed on an outer periphery thereof and the cap comprises a threaded inner periphery so that the cap is screwed onto the skirt.

6. The sealing device as claimed in claim 1, wherein the guider comprises an apron extending therefrom and linearly and a channel defined therein, the apron and the channel diametrically corresponding to each other and sequentially linearly corresponding to a handle of the container.

7. The sealing device as claimed in claim 1, wherein each tooth of the two series of teeth of the skirt and the guider is triangle.

8. The sealing device as claimed in claim 1, wherein each tooth of the two series of teeth of the skirt and the guider is trapezoid.

9. The sealing device as claimed in claim 1, wherein each tooth of the two series of teeth of the skirt and the guider has a wave-like shape.
